(19) United States
(12) Patent Application Publication
(10) Pub. No.: US 2007/0258270 A1
(43) Pub. Date: Nov. 8, 2007

(54) LED mounting device

(76) Inventor: John Scheiman, Tampa, FL (US)

Correspondence Address: Wilson Daniel Swayze, Jr, 3804 Clearwater Ct., Plano, TX, 75025, US

(21) Appl. No.: 11/429,552

(22) Filed: May 5, 2006

(51) Int. Cl. H01R 33/00

(52) U.S. Cl. 362/640

(57) ABSTRACT

A detachable LED device that is detachable from a surface includes a detachable attachment device for being detachedly connected to the surface, and a LED display for displaying characters and being connected to the detachable attachment device. The LED display can rotate 360°.

### FIELD OF THE INVENTION

The present invention relates generally to mounting devices that can be used to mount light sources.

More particular, this invention pertains to a device that can be used to mount a light emitting diode (LED) light source.

### BACKGROUND OF THE INVENTION

Light emitting diode (LED) light sources are known in the art. For example, the prior art teaches the use of light emitting diode light sources for advertising devices and for traffic signal devices. These light emitting diode devices are designed to be connected to in a power source and includes an A. C to D. C. converter that converts the power from the power supply to the device into DC power. This is the power is then used to power an array of LED devices within the light source.

The benefits of LED devices are well-known within the advertising community. The LED devices consume less power than their incandescent advertising counterparts. In addition, the LED devices have a longer usable lifespan when compared to their incandescent device counterparts.

A recent trend in advertising is to place advertising on vehicles and to have the ability to program the advertising in accordance with the needs of the advertising user. The LED devices are a natural display device for this type of advertising. However, a drawback of using LED devices in a vehicle has been the need to permanently secure the LED devices to the vehicle. This includes permanently changing the vehicle to accommodate the LED devices. These permanently secured LED devices decrease the value of the vehicle in the event that the owner desires to sell the vehicle. Furthermore, some users only wish to advertise or display information for a limited amount of time; after which, the owners of the vehicle wish to remove the LED devices from the vehicle. If the LED devices are permanently mounted, then it is difficult if not impossible to return the vehicle to its original state without screw holes or some other evidence of the mounting of the LED device being left on the vehicle.

### SUMMARY OF THE INVENTION

It is an objective of the invention to provide a mounting device for an LED device such that the LED device is detachably connected to the vehicle. Furthermore, the mounting device should be removable from the vehicle without leaving evidence of the fact that the LED device was once mounted on the vehicle.

Additionally, the mounting device should be able to mount the LED device on the window of vehicle.

Frequently, the windows of the vehicles are angled with respect to the vertical and horizontal. This is especially true for the front and rear windows of the vehicle. These windows are typically angled so that mounting the LED device on these angled windows present additional challenges.

The mounting device should allow the LED device to rotate 360° with respect to the mounting device so that the LED device can maintain a substantially vertical or maintain any orientation when mounted on a surface at an angle.

### BRIEF DESCRIPTION OF THE DRAWINGS

The invention may be understood by reference to the following description taken in conjunction with the accompanying drawings, in which, like reference numerals identify like elements, and in which:

FIG. 1 illustrates a cross-sectional view of the detachable LED device in a first position in accordance with the teachings of the present invention;

FIG. 2 illustrates a cross-sectional view of the detachable LED device in a second position in accordance with the teachings of the present invention;

FIG. 3 illustrates a circuit diagram of the LED device; and

FIG. 4 illustrates another circuit diagram of the LED device.

### DETAILED DESCRIPTION

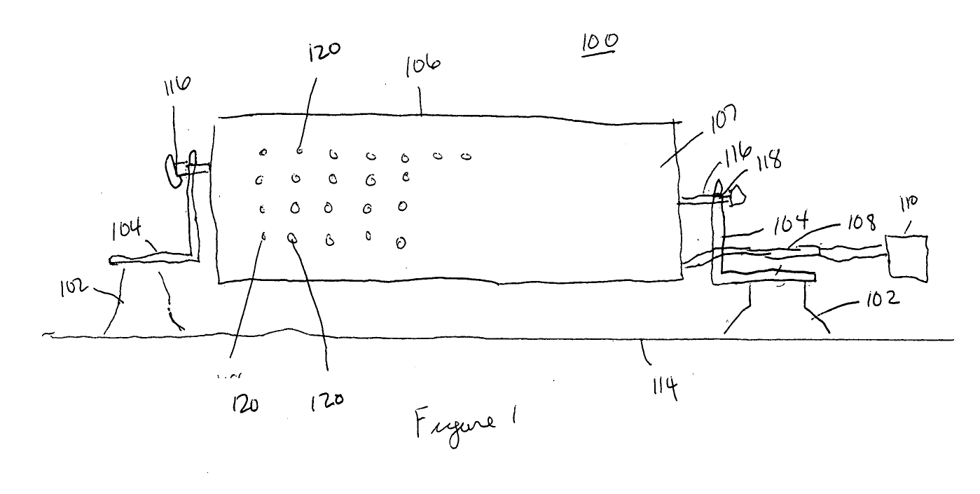

FIG. 1 illustrates a detachable LED device 100 in accordance with the teachings of the present invention. The detachable LED device 100 includes a detachable attachment device 102 to be attached and to be removed from the surface 114 without marring or disfiguring the surface 114. The detachable attachment device 102 may be a suction cup or another suitable device. FIG. 1 illustrates that a detachable attachment device 102 is positioned at each end of the detachable LED device 100. The detachable attachment device 102 is connected to an L-shaped bracket 104 on a surface of the detachable attachment device 102 which opposes the surface of the detachable attachment device 102 that is detachably connected to the surface 114. The surface 114 may be glass, plastic steel, fabric, a painted surface or any suitable surface for mounting the detachable LED device. The LED display 106 is connected to the L-shaped bracket 104 through a hole 118 positioned at one end of the L-shaped bracket 104 by a shaft 116 which may be a bolt or screw. The shaft 116 allows the LED display 106 to rotate 360° with respect to the L-shaped bracket 104 and subsequently secures the LED display 106 when the bolt or screw is tightened to prevent further rotation of the LED display 106 once the desired position is obtained. FIG. 1 additionally shows a computer 110 connected to the LED display 106 by a signal line 108 to control the LED lights 120. FIG. 1 additionally shows that the LED display surface 107 is substantially perpendicular to the surface which the detachable LED device 100 is detachably connected.

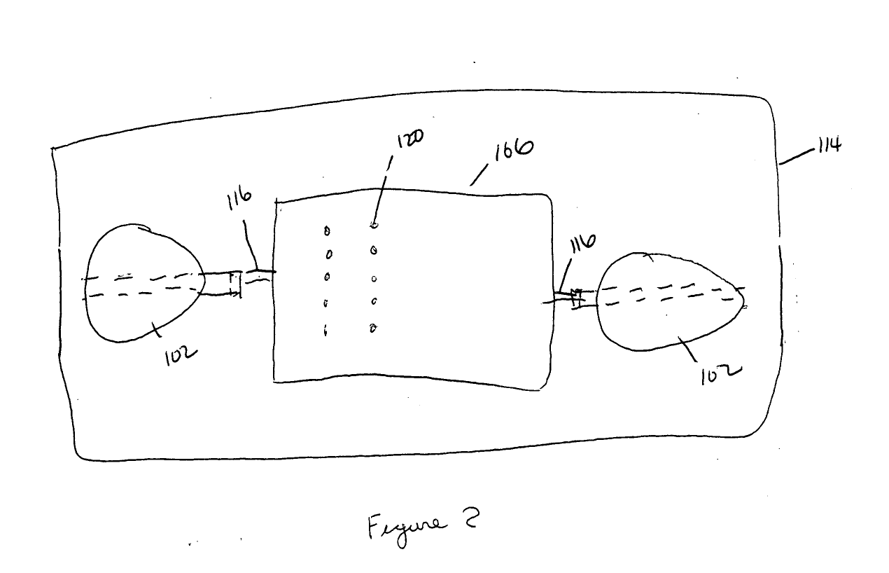

FIG. 2 illustrates the detachable LED device 100 in a second position in which the LED display 106 is substantially facing the surface 114. In this particular embodiment, the surface 114 is glass so that the detachable attachment device 102 is connected to the surface 114 of the glass. The LED lights 120 can be seen through the surface 114 and is substantially parallel to the surface 114. The LED display 106 can be rotated 360° on the shaft 116.

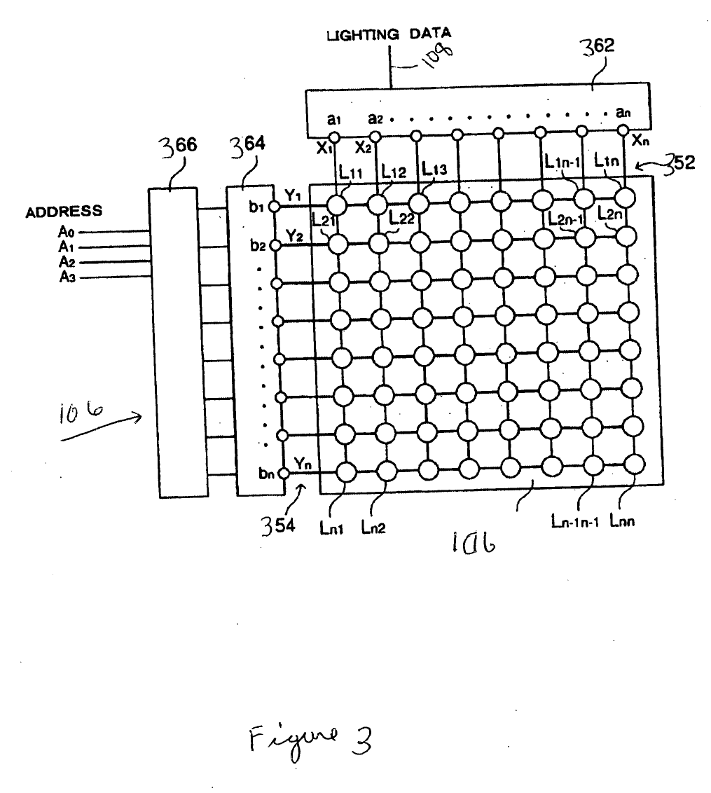

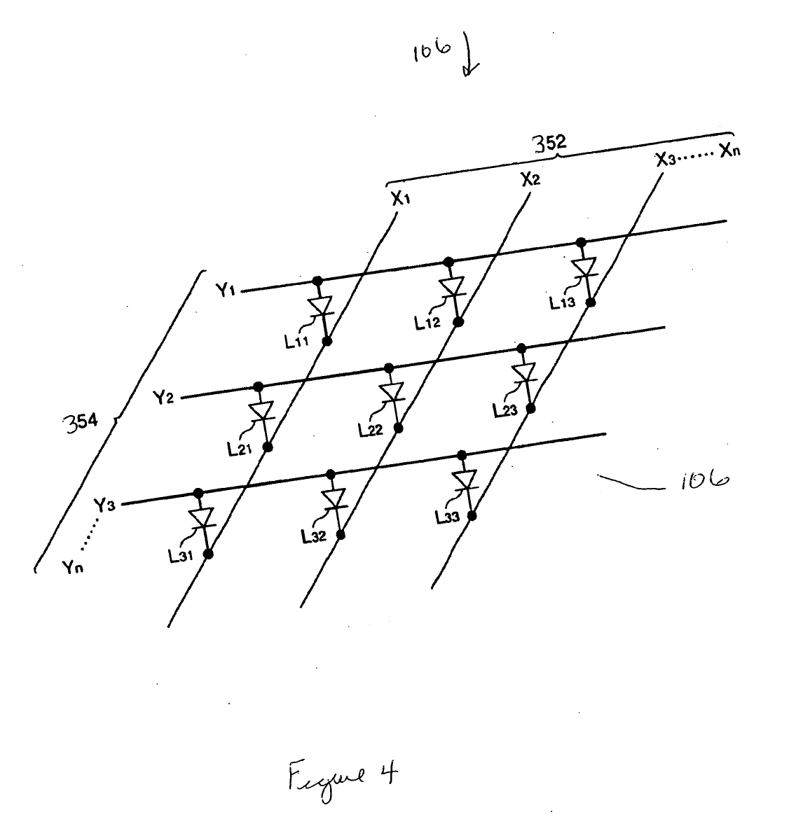

FIG. 3 is a diagram illustrating driving circuits for driving the LED display 106 as shown in FIG. 4. In FIG. 3, column lines (X lines 352) are lighting data input lines and row lines (Y lines 354) are scanning lines which are also referred to as common lines. In FIG. 3, the LEDs for example L₁₁ to Lₙₙ are arranged as a matrix on the LED display 106. LEDs in the respective columns are linearly connected by lines X₁ to Xₙ corresponding to the columns, and the LEDs in the respective rows are linearly connected by lines Y₁ to Yₙ corresponding to the rows. Lighting data for characters are displayed on the LED display 106 by inputting the lighting data to the lighting data drive circuit 362 from the computer 110. The lighting data drive circuit 362 includes a shift register, a latch and a luminance adjusting circuit. The lighting data transmitted by a signal line 108 is input to the shift register in timing with a clock timing pulse (not shown). The data of each line is latched for predetermined time and shifted in the next timing cycle. New lighting data is sequentially input to the shift register during this next timing cycle. On the other hand, the lines Y₁ to Yₙ are connected to output terminals of the scanning drive circuit (Y line drive circuit) 364 having the input side being connected to the decoder circuit 366. Address signals are input to the decoder circuit 366 from the address signal lines A₁-Aₘ. When the address signals are input to the decoder circuit 366, the output signals from the decoder circuits 366 are input to the scanning drive circuit 364 to turn line Y₁ on. The scanning drive circuit 364 next turns line Y₁ off and then turns line Y₂ on. The process is repeated sequentially through lines Y₁ to Yₙ and then begins again with line Y₁.

While the invention is susceptible to various modifications and alternative forms, specific embodiments thereof have been shown by way of example in the drawings and are herein described in detail. It should be understood, however, that the description herein of specific embodiments is not intended to limit the invention to the particular forms disclosed.

1. A detachable LED device that is detachable from a surface, comprising:
a detachable attachment device for being detachedly connected to said surface; and
a LED display for displaying characters and being connected to said detachable attachment device.

2. A detachable LED device that is detachable from a surface as in claim 1, wherein said detachable attachment device and said LED display are connected to a common connector.

3. A detachable LED device that is detachable from a surface as in claim 2, wherein said connector is an L-shaped connector.

4. A detachable LED device that is detachable from a surface as in claim 1, wherein said LED display includes a lighting data drive circuit.

5. A detachable LED device that is detachable from a surface as in claim 1, wherein said LED display includes a decoder circuit.

6. A detachable LED device that is detachable from a surface as in claim 1, wherein said LED display includes a scanning drive circuit.

7. A detachable LED device that is detachable from a surface, comprising:
a detachable attachment device for being detachedly connected to said surface; and
a LED display for displaying characters and being connected to said detachable attachment device,
wherein said LED display rotates 360°.

8. A detachable LED device that is detachable from a surface as in claim 7, wherein said detachable attachment device and said LED display are connected to a common connector.

9. A detachable LED device that is detachable from a surface as in claim 8, wherein said connector is an L-shaped connector.

10. A detachable LED device that is detachable from a surface as in claim 7, wherein said LED display includes a lighting data drive circuit.

11. A detachable LED device that is detachable from a surface as in claim 7, wherein said LED display includes a decoder circuit.

12. A detachable LED device that is detachable from a surface as in claim 7, wherein said LED display includes a scanning drive circuit.
